(19) United States
(12) Patent Application Publication
(10) Pub. No.: US 2018/0367830 A1
(43) Pub. Date: Dec. 20, 2018

(54) ACCESS PERMISSIONS AND CONTROL FOR A MOBILE VIDEO PLATFORM METHOD AND SYSTEM

(71) Applicant: Sqoony Holding B.V., Breda (NL)

(72) Inventors: Daan BEMELMANS, Breda (NL); Joep VAN GASSEL, Breda (NL)

(21) Appl. No.: 15/957,935

(22) Filed: Apr. 20, 2018

Related U.S. Application Data
(63) Continuation of application No. 15/358,289, filed on Nov. 22, 2016, now abandoned.
(60) Provisional application No. 62/258,510, filed on Nov. 22, 2015.

(51) Int. Cl. H04N 21/254; H04N 21/4363; H04W 84/12; H04N 21/414

(52) U.S. Cl. CPC H04N 21/2541; H04N 21/41407; H04W 84/12; H04N 21/43637

(57) ABSTRACT

A system for efficient, asynchronous video data delivery, comprising a mobile device and a video delivery platform, wherein said video delivery platform notifies said mobile device of availability of a video clip according to a notification message and wherein said mobile device optionally pulls said video clip from said video delivery platform according to said notification message when said mobile device is connected to a network technology that does not involve cellular telephone network data delivery. Optionally said network technology comprises WiFi. Optionally additionally or alternatively, a system for efficient, asynchronous video data delivery and display, comprising a mobile device and a video delivery platform, wherein said video delivery platform notifies said mobile device of availability of a video clip according to a notification message and wherein said mobile device pulls said video clip from said video delivery platform according to said notification message, but wherein said mobile device is only able to display said video clip according to one or more display parameters in said notification message.

### FIELD OF THE INVENTION

The present invention relates, in at least some embodiments, to a system and method for access permissions for, and control of, distributing video clips to mobile devices and in particular, to such a system and method in which obtaining video data by the mobile device and granting permission to access thereof are both preferably asynchronous with video data display.

### BACKGROUND OF THE INVENTION

Mobile devices are becoming increasingly the computational device of choice for many users. However mobile devices have some drawbacks with regard to downloading and displaying video data: video storage is limited and video providers often want to be able to control the number of times that video playback is possible and/or to prevent unauthorized sharing of video data, so video providers often prefer streaming video. However, mobile service providers, such as cellular telephone companies, often charge excessively for downloading the large amounts of data required to display a video, yet often bandwidth is quite limited. Streaming can therefore be an unpopular choice for obtaining video data, particularly since many mobile device users prefer to obtain data through WiFi, a connection which is often free or at least not metered to the extent that cellular data is.

Various attempts to provide video data in a more efficient manner have been described, but none of them overcome all of the above drawbacks. For example, US Published Application No. 20060277271 to Morse et al describes a system and method for pre-fetching content. Unfortunately this system and method does not provide for adequate control over the video data, such that video data providers would not have sufficient safeguards. US Published Application No. 20140171204 to Cox et al describes a method for asynchronous video delivery as part of playing a game, but once delivered, there are insufficient safeguards over the video data. This application also does not address the problems associated with cellular telephone network data delivery.

### SUMMARY OF THE INVENTION

None of the above described background art references teaches or suggests a system and method for access permissions for, and control of, asynchronous video data delivery and display that overcomes the problems associated with cellular telephone network data delivery. Furthermore, none of the above described background art references teaches or suggests a system and method for asynchronous video data delivery and display that overcomes the problems associated with lack of control over video data once provided to a mobile device.

The present invention, in at least some embodiments, overcomes these drawbacks of the background art by providing a system and method for efficient, asynchronous video data delivery and display, that provides flexibility in terms of the network and technology used for video data delivery. For example, optionally the mobile device may only download video data when in contact with WiFi or another network technology that does not involve cellular telephone network data delivery. Optionally, delivery through cellular telephone network data systems may be used. In at least some embodiments, the system and method includes the provision of access permissions for, and control of, distribution of video clips to mobile devices. Preferably, obtaining video data by the mobile device and granting permission to access thereof are both preferably asynchronous with video data display.

The present invention, in at least some embodiments, also provides a system and method for efficient, asynchronous video data delivery and display, that enables the video data owner or originator to control when, how, to whom and for how long the video data can be displayed on the mobile device.

Optionally, the system and method also provides interactive videos for the video clips, for example optionally including a CTA (call to action) functionality that links to and/or launches external content or in-app content. Optionally the content includes but is not limited to an external website, a landing page, a “click to call” to perform an internet call or chat, or a telephone call or chat, an email, another video, an audio file and the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), a thin client, a mobile communication device, a smart watch or other wearable that is able to communicate externally, or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A shows a non-limiting, illustrative example of a system according to at least some embodiments of the present invention;

FIG. 1B shows a non-limiting, illustrative example of a system according to at least some embodiments of the present invention, featuring communication with a customer computer;

FIG. 1C shows a non-limiting, illustrative example of a system according to at least some embodiments of the present invention, featuring communication with a mobile device;

FIG. 2 shows a non-limiting exemplary implementation of a front end 110 according to at least some embodiments of the present invention;

FIG. 3A shows a non-limiting exemplary implementation of an upload process according to at least some embodiments of the present invention;

FIG. 3B shows a non-limiting exemplary implementation of a transcoding process according to at least some embodiments of the present invention;

FIG. 4A shows a non-limiting exemplary implementation of a clip management engine 118 according to at least some embodiments of the present invention;

FIG. 4B shows a non-limiting exemplary implementation of a notification flow according to at least some embodiments of the present invention;

FIG. 4C shows a system which is a variation on the system of FIG. 4B;

FIG. 5 shows an exemplary, illustrative schematic system for determining one or more permissions for controlling at least one parameter of video display according to at least some embodiments of the present invention;

FIGS. 6A-6C show exemplary flows for permissions to be set and communicated according to at least some embodiments of the present invention; and

FIG. 7 shows an overall exemplary flow for permissions to be set and communicated according to at least some embodiments of the present invention.

### DETAILED DESCRIPTION OF SOME EMBODIMENTS

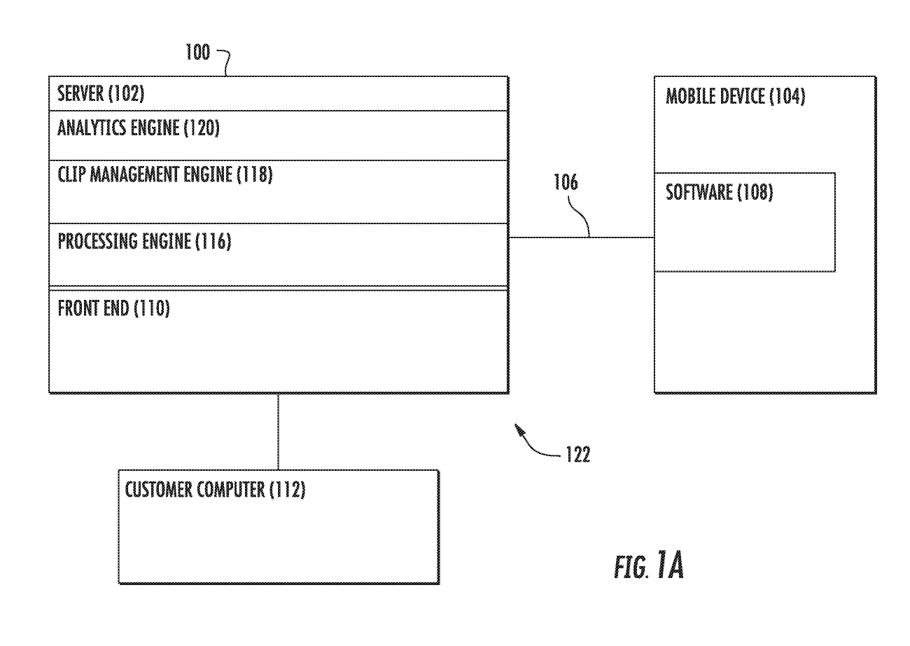

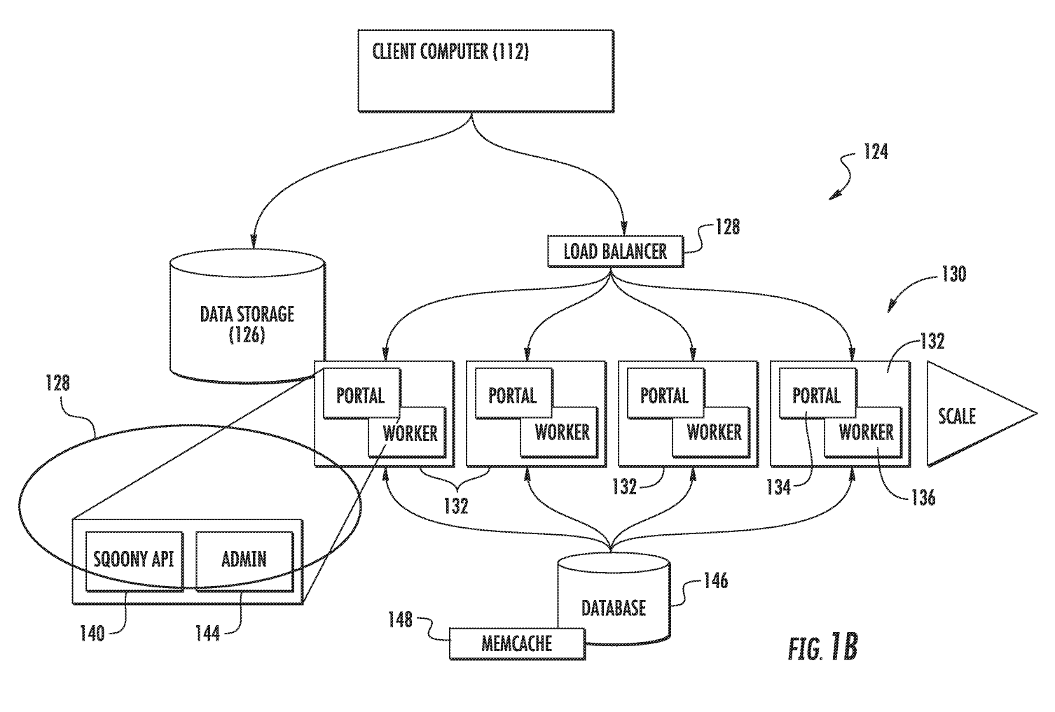

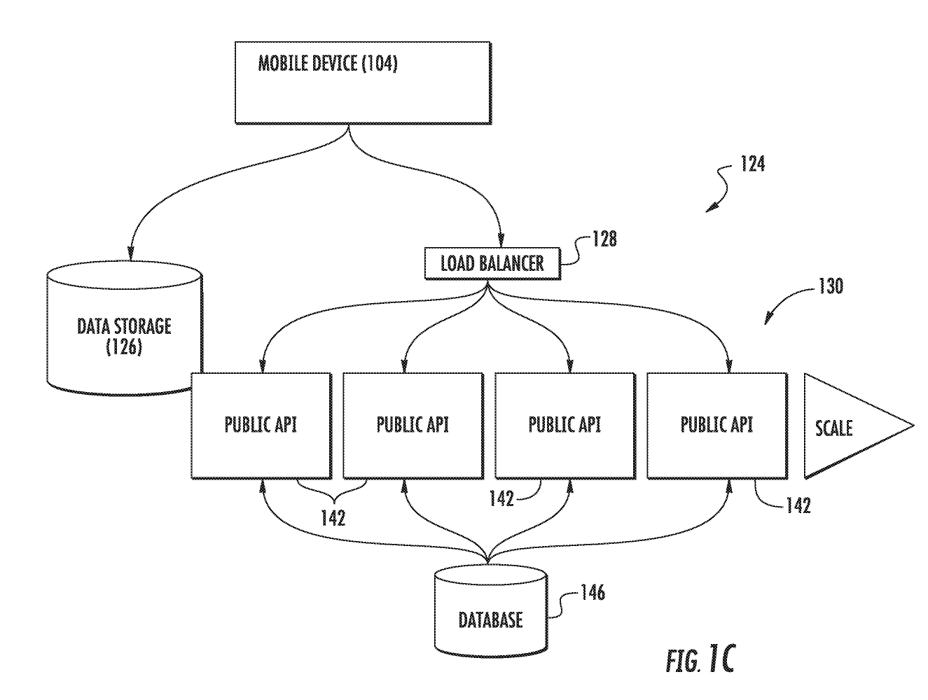

FIG. 1A shows a non-limiting, illustrative example of a system according to at least some embodiments of the present invention. As shown, a system 100 comprises a server 102 and a mobile device 104, which are in electronic communication through a computer network 106. The various components of server 102 may optionally be described as a platform 122. Computer network 106 is preferably a network such as the Internet, which may optionally be delivered through various mechanisms as described herein. In this embodiment, server 102 optionally receives uploaded videos and is able to provide such videos to mobile device 104 through computer network 106. In other embodiments shown below, uploaded videos are uploaded to an external storage and delivery system, such as a CDN (content delivery network) for example (not shown).

Computer network 106 preferably features at least two delivery mechanisms, including a cellular data network and a wireless LAN (local area network; neither shown), for provision of videos to mobile device 104. Non-limiting examples of cellular data networks include a GSM based network (e.g., GPRS, EDGE, UMTS, HDSPA/HSUPA, LTE, 3GPP, 3GPP2), CDMA-based network (CDMA2000, WCDMA, EVDO, LTE, etc.), a cellular data packet based network or any suitable cellular data connection or cellular telephony network connection that is capable of supporting data transfer. Non-limiting examples of a wireless LAN include any type of connectivity known as “WiFi”, any wireless network using 2.4 GHz UHF and 5 GHz SHF ISM radio bands, IEEE 802.11 Wi-Fi LAN, 802.16 WiMAX LAN, or any suitable WLAN.

Mobile device 104 comprises a software 108 for displaying a video to a user (not shown). The user may optionally select a delivery modality, whether cellular telephone network or wireless LAN network, through software 108, which in turn provides these instructions to server 102 for controlling delivery of the video. As a non-limiting example, software 108 can indicate to server 102 when mobile device 104 is connected to computer network 106 through the desired delivery mechanism, such that delivery of the video or videos only begins upon receipt of such signal.

Server 102, in at least some embodiments, comprises a front end 110 for receiving an uploaded video from a customer computer 112 through computer network 106. Front end 110 preferably communicates with customer computer 112 and receives the uploaded video. Optionally and preferably, customer preferences may optionally be indicated through front end 110, including but not limited to specifying a start day and/or time of display (before which the video cannot be displayed through mobile device 104) and an ending (or stop) day and/or time of display (after which the video cannot be displayed through mobile device 104). Additionally, the customer may optionally indicate through front end 110 a channel through which the video is to be displayed, as described in greater detail below, whether the video is private or public, and so forth.

Other optional parameters include but are not limited to a title, CTA (call to action), any pre/post roll (if any), advertisements or a description of the video. Optionally a video thumbnail is created at this point. Additional details are provided below.

Uploaded video is then processed by a processing engine 116, which includes transcoding capabilities, preferably at least operating system and/or device specific transcoding capabilities, but also optionally adjustable according to parameters such as the need for greater fidelity or greater compression etc, also as described in greater detail below.

After processing, a clip management engine 118 receives an indication that the video is ready and also a determination of which mobile devices 104 are to receive the video. As used herein, the terms “clip” or “video clip” are used to mean any suitable type of video data unit, optionally including a file or the like. Clip management engine 118 then preferably prepares a message to send to selected mobile devices 104 as a push notification. The message is then received by software 108 which parses the message as described in greater detail below.

According to the message parameters, software 108 is able to determine which video is to be received from server 102, whether by push, pull or a combination thereof. Software 108 also preferably determines at least the initial period (day and/or time) when the video may be displayed to the user through mobile device 104, and optionally also the end of the display period as described above. The message may also optionally indicate when the retrieval process of the video may begin, for example through a pull mechanism from software 108 to server 102, as described in greater detail below.

According to at least some embodiments, software 108 initiates the retrieval process according to the connectivity state of mobile device 104 on network 106, and specifically whether the delivery modality of network 106 is a cellular network or some other type of network, such as a wireless LAN network for example. Different modality types may optionally result in different charges, latency or have other differences which may make one such modality more desirable. For example, wireless LAN network connections are typically not metered while cellular networks typically are metered; therefore, the former may be more desirable under at least some circumstances. This process is described in greater detail below.

Next, uploaded video is received by mobile device 104 and is preferably stored on mobile device 104. Optionally and more preferably, mobile device 104 receives and stores the video before the initial display period begins, such that initially the user cannot access the video on mobile device 104. However, this also means that mobile device 104 preferably does not need to be in communication with computer network 106 while the video is being displayed to the user. Optionally, a portion of the local storage on mobile device 104 is set aside in advance, to permit future videos to be retrieved. Optionally this portion may be set as a percentage of the free space available and/or as an absolute minimum. Also optionally, the user is able to adjust this amount.

Upon watching the video on mobile device 104, the user may optionally interact with the video, for example by clicking on a CTA (call to action) indicator, such as a button, which may then optionally launch additional content, including but not limited to a landing page or another HTML document, a telephone call, an email message and so forth. Such content is optionally provided in-app or as external content, through such CTA functionality, which is provided through pre-roll or post-roll. Optionally the additional content is launched within software 108 in order to maintain the display even when mobile device 104 is not in communication with computer network 108.

Optionally such CTA functionality could be provided by “native” CTA (already in the video clip) or can be added to the video clip. The pre/post rolls may also optionally feature native or added CTAs.

According to at least some embodiments, information regarding the behavior of the user with the video is preferably passed from software 108 to an analytics engine 120 at server 102. Such user behavior optionally includes but is not limited to whether the user watched it, for how long, when the user watched it, where the user watched it (if geolocation functionality is activated), whether the user has permitted automatic video playing for this channel (through which the video is distributed) or generally for the app, and if not, how long after notification before the user requested to play the video clip; whether the user requested to access additional content through a CTA (call to action) functionality, which is described in greater detail below, and so forth.

Optionally, preferably if the user permits, information such as a telephone number associated with mobile device 104 and/or the IMEI of mobile device 104 is uploaded to server 102.

Data could optionally be analyzed at server 102 for data mining and to determine market knowledge, and/or could be provided to the customer (for example through customer computer 112) for performing data mining and/or other types of market analytics. Such analytics could optionally be specifically used, for example, for determining the efficacy and “stickiness” of native advertising (advertising delivered as content in a video clip, as opposed to separate advertising) and/or of regular pre and/or post roll advertising.

FIG. 1B shows another exemplary, non-limiting implementation of a platform according to at least some embodiments of the present invention. As shown, a platform 124 preferably comprises a data storage 126 and a load balancer 128, both of which are preferably in bi-directional communication with client computer 112. Client computer 112 is able to upload videos, thumbnails and other information to data storage 126, for example in the form of video clips to be shown, as described in greater detail below. Data storage 126 may optionally be any type of BLOB (Binary Large OBject) storage or other storage type. Optionally data objects which then provide information on the video clips to be retrieved may be stored in data storage 126 but alternatively are stored elsewhere, as described in greater detail below.

Load balancer 128 preferably distributes job requests for uploading videos and other information to a processor 130, comprising a plurality of working instances 132, of which four are shown for the sake of clarity and without any intention of being limiting. Each working instance 132 comprises a portal 134 and a worker 136. As shown in close-up 138, each portal 134 in turn comprises a platform API 140 and an admin module 144.

Admin module 144 supports an administrative console so that customer computer 112 is able to manage content, such as video clips and data about these clips, and also parameters related to customer computer 112 itself. Optionally admin module 144 enables customer computer 112 to manage uploading of video content, whether through processor 130, directly to data storage 126 and/or to an external system, such as a CDN (not shown). Admin module 144 may also optionally operate parameters related to customer computer 112, for better interaction between customer computer 112 and platform API 140. Preferably, actions involving communication with processor 130 are managed by admin module 144 through platform API 140. Admin module 144 may optionally be augmented and/or replaced by software operating on customer computer 112 (not shown).

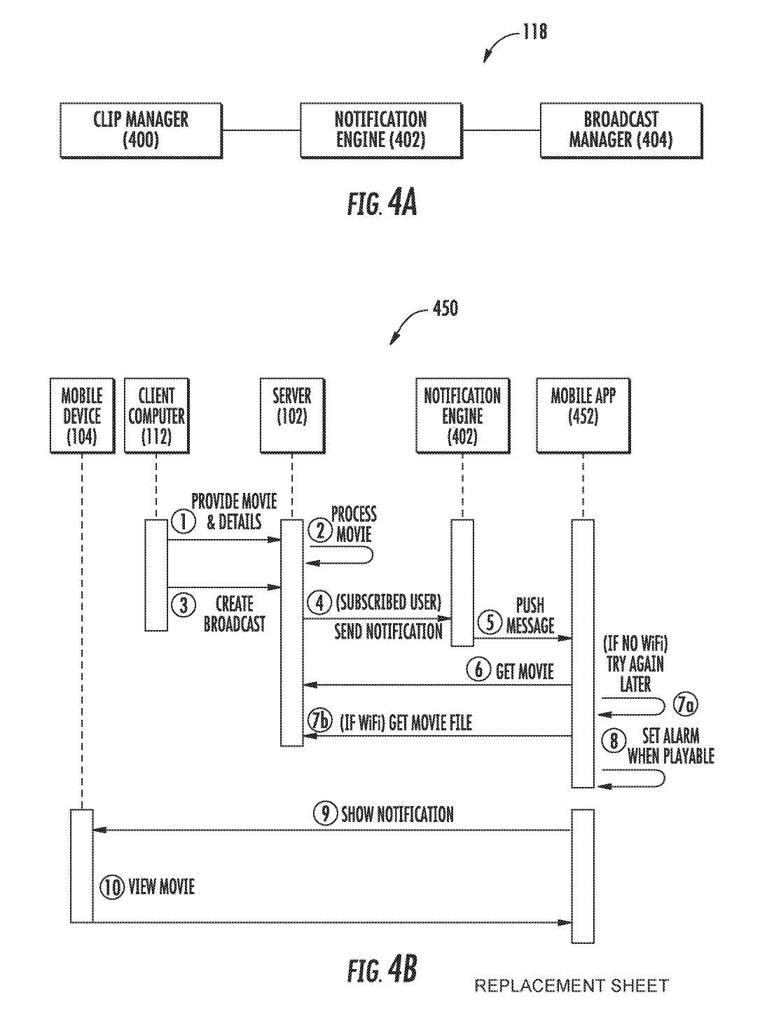

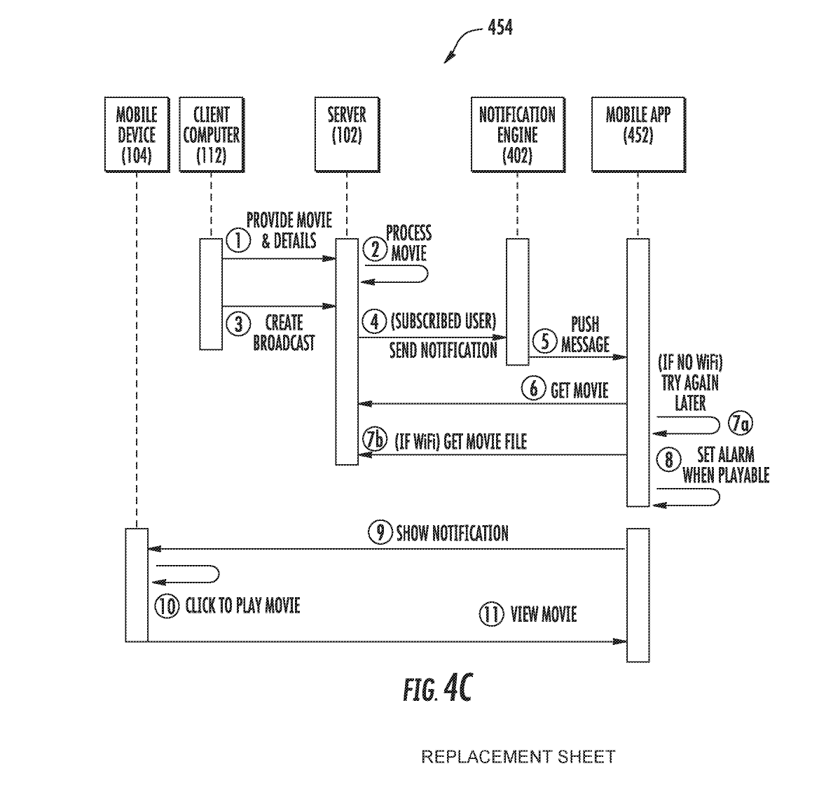

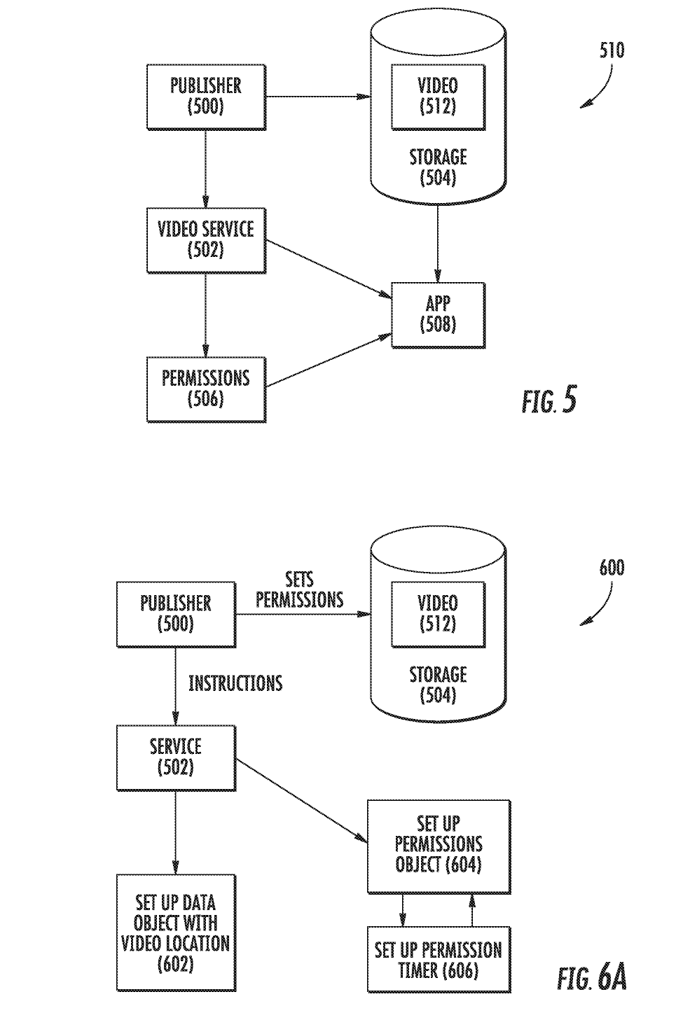

At start-up of a session, each worker 136 registers itself with a database 146. Database 146 is optionally any type of suitable database, such as an SQL database for example, for storing metadata and other information about the video clips, such as when the video clip may first be displayed for example, but preferably does not store the actual video data. Instructions for downloading the video clip by mobile device 104 (not shown) are also optionally stored in database 146, for example in the form of a JSON object; such instructions are optionally and preferably provided to a notification engine (not shown; see FIGS. 4A and 4B).

A memcache server 148 is optionally provided to maintain persistence of sessions; otherwise, at the end of each session, each working instance 132 shuts down and is restarted at the beginning of each session. Memcache server 148 optionally operates with database 146 to provide a persistence layer.

Each worker 136 preferably has two processes operating, a transcoder process and a notification process (not shown). The transcoder process performs transcoding of the uploaded video clips. The notification process relates to notification to mobile device 104, for a new video clip to be pulled from data storage 126 (not shown).

FIG. 1C shows platform 124 according to interactions with mobile device 104. Optionally the components of platform 124 as shown may be combined with those in FIG. 1B (not shown). Mobile device 104 communicates with load balancer 128 to retrieve video clips and optionally also instructions for downloading these video clips. Load balancer 128 distributes the sessions with various mobile devices 104 to one of a plurality of public APIs 142 in processor 130. Information about the video clips, optionally including instructions for retrieving the video clips, is obtained from database 146, while the actual video clips are optionally downloaded from data storage 128 (or alternatively from an external system as previously described).

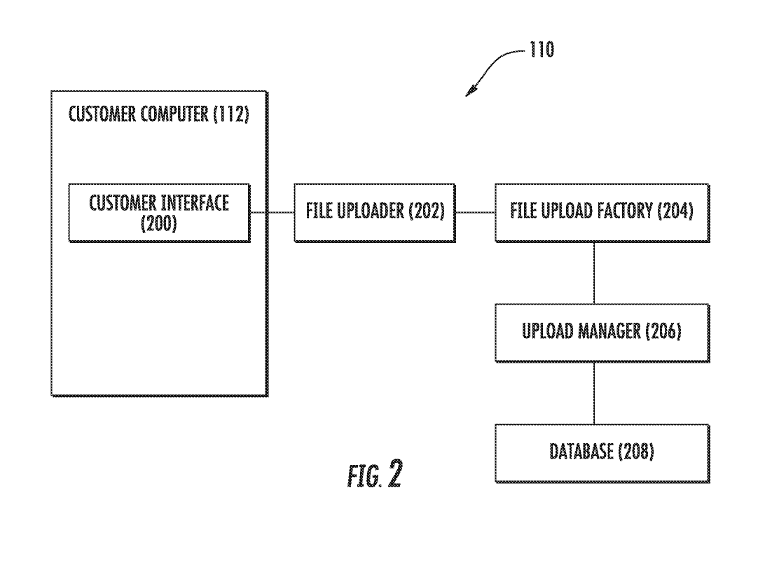

FIG. 2 shows a non-limiting exemplary implementation of a front end 110 according to at least some embodiments of the present invention. As shown, front end 110 preferably comprises a file uploader 202, a storage upload factory 204 and an upload manager 206. In addition, front end 110 optionally and preferably comprises a database 208, although database 208 may optionally be provided as part of server 102 or externally to server 102. For example, database 208 may optionally be configured as data storage 126 of FIGS. 1B and 1C.

As shown, customer computer 112 operates a customer interface 200 for uploading at least the video data, optionally in the form of a “clip”. However, the customer user may optionally also specify additional parameters, such as a title, description, and other video related information through customer computer 112. Preferably, the time and/or date of the initial permitted display of the video on mobile device 104 (not shown) is also configured through customer interface 200. Optionally and preferably, the channel through which the uploaded video is to be delivered is also specified through customer interface 200 and is optionally stored in database 208.

The channel is optionally and preferably associated with a plurality of specific mobile devices 104, according to characteristics determined by the customer through customer computer 112. For example and without limitation, the channel may optionally be determined according to subscribers, who are users associated specific mobile devices 104 and who have registered to a particular channel to receive videos associated with that channel. As described in greater detail below, the registration process may optionally occur through customer computer 112 (or another customer associated computational device) and then be provided through customer interface 200, or alternatively may occur directly through server 100. Regardless of how the association occurs, preferably a channel is associated with specific mobile devices 104 according to some type of association.

Optionally and more preferably, the customer may provide additional content to be associated with the video, including but not limited to a CTA (call to action) functionality, optionally with further associated content, pre or post roll, and/or an advertisement, through customer interface 200. Optionally such content is uploaded through customer interface 200; alternatively, the customer may specific the location of such content through customer interface 200. Such content may optionally be external content and/or may optionally be displayed in-app.

File uploader 202 of front end 110 receives the video data, and optionally other content as described above, from customer interface 200. The video data, and optionally other content data, is then passed to upload factory 204 for storage in database 208 as controlled by upload manager 206.

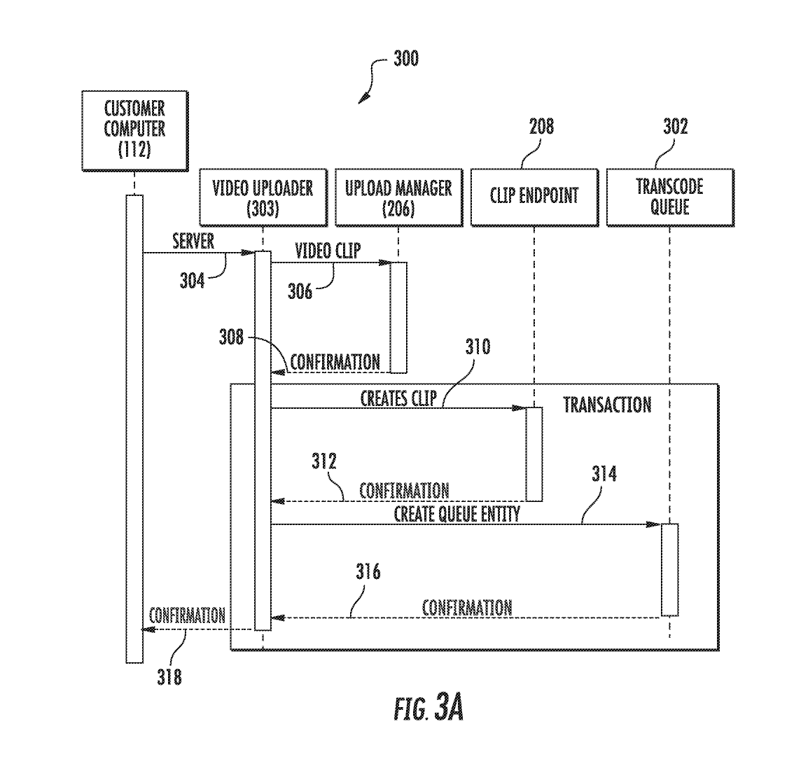

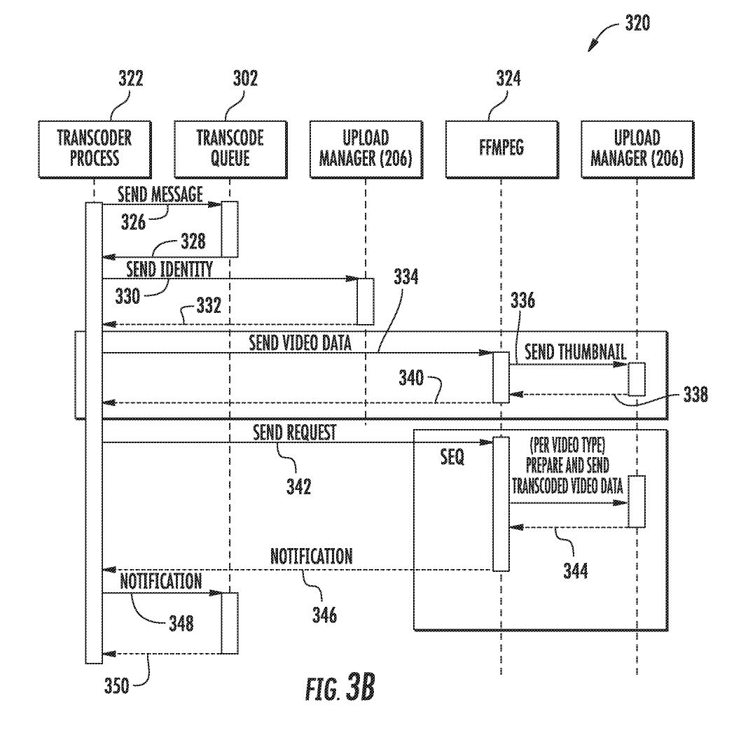

An exemplary, non-limiting upload process is shown in FIG. 3A while an exemplary, non-limiting transcoding process is shown in FIG. 3B.

FIG. 3A shows a non-limiting exemplary implementation of an upload process according to at least some embodiments of the present invention. As shown, an upload process 300 preferably involves various entities as shown, which perform a flow to upload a video clip from customer computer 112. In stage 304, process 300 begins with customer computer 112 submitting a video clip to a video uploader 303, which may optionally include various components from front end 110, such as file uploader 202 for example. Next, in stage 306, the video clip is passed to upload manager 206. Confirmation of the successful upload is passed in stage 308 from upload manager 206 to video uploader 303; optionally, such confirmation may be passed also to customer computer 112 (not shown).

Next, a plurality of stages 310-316 is optionally performed, labeled as a “transaction” in the diagram. In stage 310, video uploader 303 creates a clip entity in database 208. In stage 312, database 208 confirms that the entity was created to video uploader 303. Video uploader 303 then instructs a transcode queue 304 to create a queue entity in stage 314. In stage 316, transcode queue 304 confirms that the queue entity was successfully created to video uploader 303. In stage 318, video uploader 303 confirms success of the entire uploading process to customer computer 112.

Any video can contain a thumbnail or a pointer to a thumbnail, such as a thumbnail URL. Optionally such a thumbnail or thumbnail pointer is provided in the video upload from customer computer 112. If the thumbnail or pointer was not provided, optionally the upload process 300 includes creating one based on the uploaded video clip, for example by taking a frame from the clip. Optionally the thumbnail or pointer is created by video uploader 303.

FIG. 3B shows a non-limiting exemplary implementation of a transcoding process according to at least some embodiments of the present invention. As shown, a transcoding process 320 preferably involves various entities as shown, which perform a flow to transcode an uploaded video clip. Optionally such transcoding is at least operating system and/or device specific. Information for determining how transcoding is to be performed is preferably stored in a transcoding database (not shown), which may optionally be part of database 208, or may optionally be located at server 102 or externally to server 102 (not shown).

In stage 326, a transcoder process 322 sends a message to transcode queue 304 to obtain the next queue entity in the queue, thereby setting the transcoding process status for that entity to “transcoding”. In stage 328, transcode queue 304 sends the identity of the next queue entity to be transcoded. In stage 330, transcoder process 322 sends the identity of the next queue entity to upload manager 206 in order to obtain the uploaded video clip. In stage 332, upload manager 206 returns the video clip to transcoder process 322.

In stage 334, transcoder process 322 sends the video data to a transcoder 324, with a request to create a thumbnail. Transcoder 324 optionally performs transcoding according to one or more parameters in the transcoding database (not shown); optionally there are multiple different transcoders 324 for different types of transcoding. Non-limiting examples of suitable CODECS include MPEG-4, as well as any CODEC implemented by FFMPEG, preferably including such file types as .mp4, .mov, .avi and .wmv; as well as any suitable transcoding service, such as the transcoding service of Amazon.

In stage 336, transcoder 324 creates the thumbnail and sends it to upload manager 206, which in turn transmits it to transcoder process 322 in stage 340. In stage 338, optionally a thumbnail is created by upload manager 206 if one is not already uploaded. The thumbnail is preferably created from one of the initial frames, say in the first second, but optionally and preferably not one of the very first frames, to avoid creating a thumbnail during a video “fade-in” visual transition. As a non-limiting example, the thumbnail is optionally created from the 24^{th} video frame. The video thumbnail is then provided to transcoder 324 for transcoding.

In stage 342, transcoder process 322 sends a request to transcode the video data to transcoder 324, which then transcodes the video data and transmits it to upload manager 206 in stage 344.

In stage 346, transcoder 324 notifies transcoder process 322 that the video data was transcoded. Transcoder process 322 notifies transcode queue 304 to set the transcoding process status for that entity to “transcoded” in stage 348. In stage 350, transcode queue 304 acknowledges completion of the request.

FIG. 4A shows a non-limiting exemplary implementation of a clip management engine 118 according to at least some embodiments of the present invention. Clip management engine 118 preferably includes a clip manager 400, a notification engine 402 and a broadcast manager 404. Clip manager 400 receives the transcoded video data, and optionally other content, that is to be delivered to mobile device 104 (by “receiving such data” it is noted that a pointer or other indicator as to the location of the data may be provided; this convention is used throughout the instant specification).

Clip manager 400 then preferably passes on the clip meta information to broadcast manager 404, including but not limited to the size of the packaged clip, the date and/or time on which the clip may be downloaded to mobile device 104, the date and/or time on which the clip may be first displayed by mobile device 104 and so forth.

Broadcast manager 404 then preferably prepares a set of instructions for mobile device 104, including the above limitations on downloading and display. Broadcast manager 404 then indicates to notification engine 402 that information is ready for retrieval to mobile device 104 and also a determination of which mobile devices 104 are to receive the video.

Notification engine 402 preferably prepares a notification message which is then sent or pushed to selected mobile devices 104, for example optionally according to the previous channel determination. Upon receipt of the push message, mobile device 104 preferably then pulls or retrieves the set of instructions, which for example may optionally be packaged as a JSON object, from server 102. Alternatively, as described with regard to FIG. 4B below, the set of instructions may optionally be contained within the initial notification message.

Mobile device 104 then parses the set of instructions, preferably with a native app (not shown). According to the instructions, mobile device 104 preferably retrieves the video clip and then displays it. This process preferably does not involve polling or other actions by either server 102 or mobile device 104.

FIG. 4B shows a non-limiting exemplary implementation of a notification flow according to at least some embodiments of the present invention. In a process 450, a mobile app 452 is operated by mobile device 104. In addition, process 450 features client computer 112, server 102 and notification engine 402.

Process 450 optionally and preferably starts as customer computer 112 uploads a video in stage 1, in this example to server 102 (although as described herein different implementations are possible). Preferably scheduling and other information is also provided through customer computer 112 at this stage or at least before notifications are sent to mobile devices. In stage 2, server 102 processes the video, for example with transcoding as described herein. After processing (or optionally simultaneously with processing), in stage 3, customer computer 112 creates a broadcast by sending information to server 102 regarding when the video can first be downloaded and then viewed on mobile device 104, and also regarding which subscription channel is to be used for broadcasting information about the video.

In stage 4, server 102 sends a notification regarding the new video to notification engine 402. This notification preferably includes the location of the video storage (that is, information necessary to be able to retrieve the video), metadata about the video (length, size etc) and/or any restrictions on when the video can be displayed by mobile device 104, optionally including but not limited to an initial display date and time, and/or a finishing (end) display date and time. Server 102 may optionally indicate which channel(s) can be used to distribute the video. Preferably, notification engine 402 receives information about the channel to be used for displaying the video data before the push message is prepared, so that notification engine 402 knows which mobile devices are to receive the push message. In this sense a “channel” may optionally feature a group of specific mobile devices that are associated with a particular set or type of notification.

Notification engine 402 prepares a push message, which is then sent in stage 5. The push message may optionally direct mobile device 104 as to the location of a data object with instructions to retrieve the video or alternatively may include these instructions within the push message itself. Optionally every subscriber to a particular channel, which is to receive the video, receives a push notification, for example optionally through a notification service such as Amazon SNS (Simple Notification Service).

As a non-limiting example of a message structure, the push notification optionally contains the following information:

{

• “readyToAir”: true,
• “broadCastId”: 2,
• “channelName”: “SomeBrand”,
• “clipUrl”: “http://videohost//someclip-with-SomeBrand.3gp”.
• “clipTitle”: “SomeBrand is great”,
• “scheduledFor”: “15-2-2015 14:20:00”,
• “durationInSeconds”: 80

}

In this example, the first parameter states that a new video is available for download. The second parameter relates to the broadcaster (the provider of the video data) while the third parameter is the name of the channel that is being used for the notifications. The clipURL is a non-limiting example of a way in which the clip download address may be provided. The clip title indicates. The time and date on which the video data may optionally be first displayed is indicated as “scheduledFor”; optionally an end time and date may be provided. The length of the video is indicated as “durationInSeconds”.

Optionally, mobile device 104 operates a software client (not shown), which “wakes up” upon receiving the notification message, such that this software client may perform the following stages.

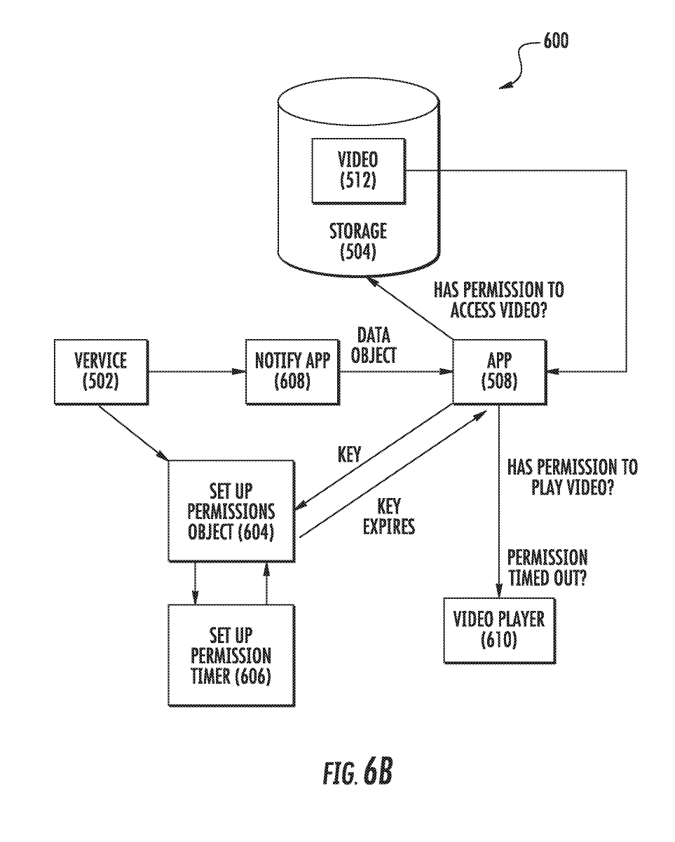

In stage 6, mobile device 104 retrieves the video according to the instructions provided, optionally from server 102 or an associated storage, and/or from another storage system as described with regard to FIG. 5. The process of pulling the video is then performed in stage 7b, although if there is no WiFi as described above, optionally mobile device 104 waits until such a computer network connection is available, as shown in stage 7a.

For example, mobile device 104 may optionally detect the availability of a LAN connection which is either not metered or less metered than a typical cellular telephone data connection. As noted above, WiFi collectively refers to a type of communication technology which is usually not metered or less metered (by “less metered” it is meant that usually data may be downloaded up to a certain ceiling or at a certain speed). Mobile device 104 may optionally determine that such a connection is available as described for example in US Published Application No. 20130155876 to Potra et al.

In stage 8, an alarm is preferably set when the movie is playable, for example by mobile device 104 or alternatively by mobile app 452. Optionally when the download is completed successfully, the local mobile device app schedules a local push notification at the “scheduledFor” date, telling the user that a video is available for watching. In stage 9, the alarm is indicated to the user through mobile app 452 and/or through having the video display start automatically (not shown). In stage 10, the video automatically starts playing. Optionally, mobile app 452 does not include a video player; instead, mobile app 452 directs an existing video player on mobile device 104 to display the video.

FIG. 4C shows a variation on FIG. 4B, with a system 454. Stages 1-9 are performed as for FIG. 4B. In stage 10, rather than starting to play the video automatically, mobile app 452 needs the user to indicate when the video is to be played, so that the user directs the video to be played by interacting with mobile app 452. In stage 11, the video starts playing. Optionally, as described above, mobile app 452 does not include a video player; instead, mobile app 452 directs an existing video player on mobile device 104 to display the video.

FIG. 5 shows an exemplary, illustrative schematic system for determining one or more permissions for controlling at least one parameter of video display according to at least some embodiments of the present invention. As shown a system 510 features a publisher 500 for publishing one or more videos for distribution by the video distribution as described herein and as shown in FIG. 5 according to some embodiments. Publisher 500 communicates at least information about the video to a video service 502, including one or more permissions that determine at least some aspects of how the video is displayed and that are stored in a permissions module 506.

The video itself may optionally be stored in a storage 504 by publisher 502 as shown, or alternatively may be placed in storage 504 by video service 502 (not shown). Storage 504 may also optionally control one more aspects of access to videos that are stored, shown in video storage 512.

Video service 502 notifies an app 508 or other software, for example operated by a mobile telephone as previously described, that a video is available for download. Video service 502 may optionally push this information to app 508 in a message as previously described. App 508 then preferably pulls the necessary permission parameters and information from permissions 506 and then pulls the video from video storage 512. The permission parameters optionally include information that is necessary for app 506 to be able to display the video and/or to enable another software to display the video (not shown), such as decryption information for example.

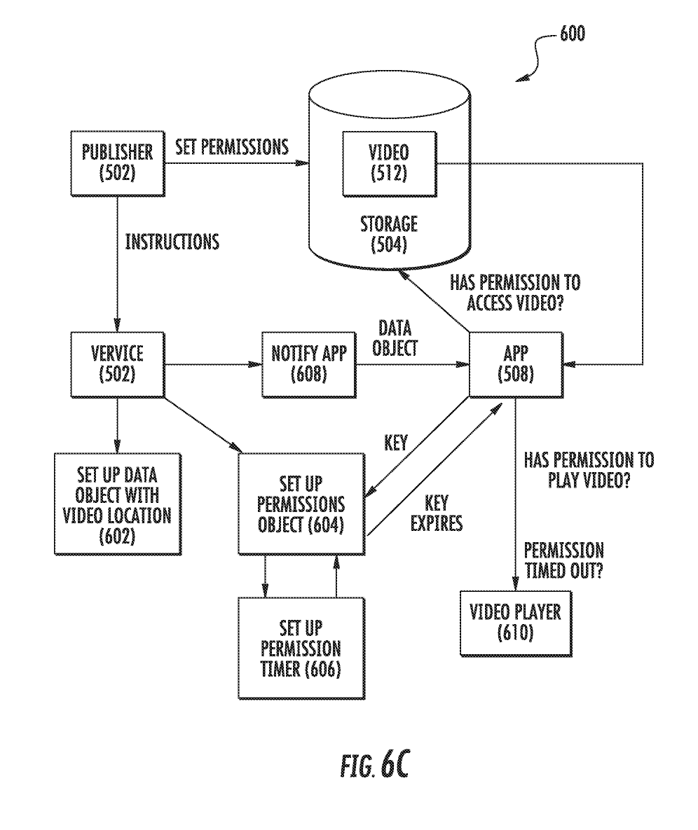

FIGS. 6A-6C show exemplary flows for permissions to be set and communicated according to at least some embodiments of the present invention. FIG. 6A shows a flow through a system 600. As shown, publisher 500 sets permissions for retrieval from video storage 512, to storage 504, which then controls access to video storage 512. Publisher 500 then sends instructions to video service 502 with regard to the timing of distribution and display of the video by app 508 (not shown).

Video service 502 then sets up a data object with the video location in video storage 512 as shown in function 602, according to information provided by publisher 500. Video service 502 then sets up a permissions object 604, which determines which permissions the app (not shown) will need to be able to decrypt the video, or otherwise access it. Optionally, video service 502 also sets up a permission timer 606, which determines the time period during which the app can download and/or access the video.

FIG. 6B shows this flow in terms of the functions of app 508. Service 502 sets up permissions object 604 and optionally permission timer 606 as previously described. Service 502 then notifies app 508 in function 608, preferably including a data object which describes the location of the permissions and also of the video. App 508 then pulls the decryption or other access key from permissions object 604 and optionally also receives a determination of when the key expires. App 508 then pulls the video from video storage 512 if permission has been granted to retrieve it. App 508 is also preferably in communication with a video player 610, which preferably can only play the video when the permissions state that display is possible, and preferably only for the period of time that such display is permitted, before the key expires.

FIG. 6C shows the overall system flow, functioning as described above.

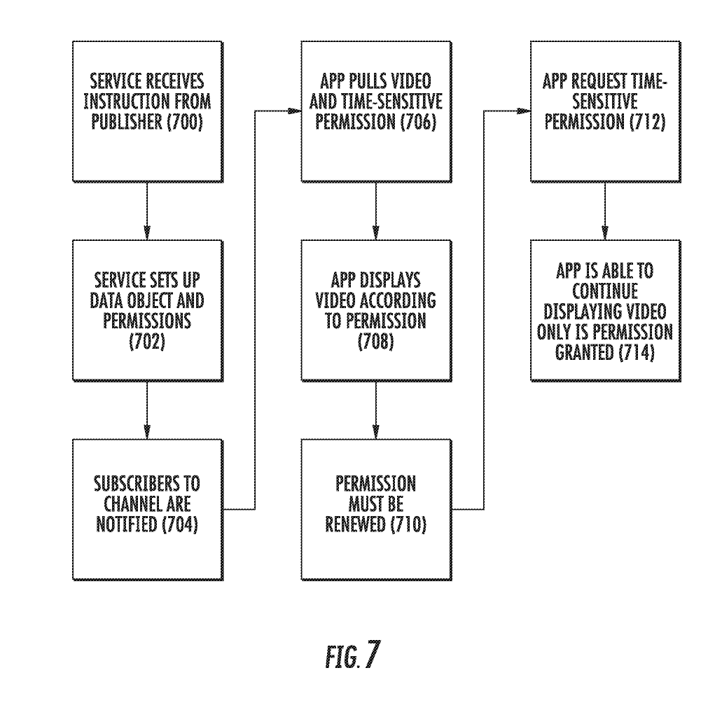

FIG. 7 shows an overall exemplary flow for permissions to be set and communicated according to at least some embodiments of the present invention. As shown, in stage 700, the video distribution service receives instruction from the video publisher, regarding a new video to be distributed to a plurality of apps.

In stage 702, the video distribution service sets up the data object with information regarding the location of the video to be retrieved and also of the permissions associated with the video. In stage 704, subscribers to channel are notified. By subscribers it is meant software operated by a computational device that communicates with the video distribution service; such communication is preferably determined according to one or more channels, as previously described.

In stage 706, the app pulls video and time-sensitive permission information from the relevant modules as previously described. In stage 708, the app displays video according to the retrieved permission information. Optionally the permission is time sensitive and more preferably expires, such that in stage 710 the permission preferably must be renewed. In stage 712 the app optionally again requests a time sensitive permission. In stage 714, the app is preferably only able to continue to enable video display if the permission is renewed.

While the invention has been described with respect to a limited number of embodiments, it will be appreciated that many variations, modifications and other applications of the invention may be made, including different combinations of various embodiments and sub-embodiments, even if not specifically described herein.

1. A system for efficient, asynchronous video data delivery,
comprising a mobile device, a video control software and a video display software operated by said mobile device and a video delivery platform in communication with said mobile device, wherein said video delivery platform notifies said video control software of said mobile device of availability of a video clip according to a notification message and wherein said video control software of said mobile device pulls said video clip from said video delivery platform according to said notification message when said mobile device is connected to a network technology that does not involve cellular telephone network data delivery, and wherein said video delivery platform further delivers at least one permission to said mobile device with said notification message, such that said video control software of said mobile device causes said video display software to display said video according to said at least one permission.

2. The system of claim 1, wherein said network technology comprises WiFi.

3. A system for efficient, asynchronous video data delivery and display, comprising a mobile device a video control software and a video display software operated by said mobile device and a video delivery platform in communication with said mobile device, wherein said video delivery platform notifies said video control software of said mobile device of availability of a video clip according to a notification message and wherein said mobile device pulls said video clip from said video delivery platform according to said notification message, but wherein said mobile device is only able to display said video clip according to one or more display parameters in said notification message, wherein said one or more display parameters comprise one or more permissions, such that said video control software of said mobile device causes said video display software to display said video according to said at least one permission.

4. The system of claim 3, wherein said display parameters relate to one or more of when, how, to whom and for how long the video clip can be displayed on the mobile device.

5. The system of claim 4, wherein said mobile device pulls said video clip from said video delivery platform according to said notification message when said mobile device is connected to a network technology that does not involve cellular telephone network data delivery.

6. The system of claim 5, wherein said network technology comprises WiFi.

7. The system of claim 3, wherein said mobile device pulls said video clip from said video delivery platform according to said notification message when said mobile device is connected to a network technology that does not involve cellular telephone network data delivery or when said mobile device is connected to a cellular telephone network.

8. The system of claim 7, further comprising providing an interactive video for said video clip.

9. The system of claim 8, further comprising a CTA (call to action) functionality that links to and/or launches external content or in-app content.

10. The system of claim 9, wherein said content comprises an external website, a landing page, a “click to call” to perform an internet call or chat, or a telephone call or chat, an email, another video, an audio file and the like.

11. The system of claim 10, wherein said CTA functionality is provided through pre-roll or post-roll.

12. The system of claim 11, further comprising analyzing user behavior in regard to interacting with the video dip by said video platform.

13. The system of claim 11, wherein said video platform further comprises a permissions module for determining one or more permissions for displaying the video, wherein said one or more permissions are set by said video platform and wherein said mobile device receives said one or more permissions from said permissions module.

14. The system of claim 13, wherein said permissions module further comprises a permissions timer, for determining a time period during which said one or more permissions are valid, such that said mobile device needs to acquire one or more new permissions after said one or more permissions expire.

15. The system of claim 14, wherein said one or more permissions are time sensitive and wherein said mobile device needs to receive one or more new permissions after said one or more time sensitive permissions expire.
